(19) United States
(12) Patent Application Publication
(10) Pub. No.: US 2019/0222919 A1
(43) Pub. Date: Jul. 18, 2019

(54) Augmented Reality Audio System for Enhanced Face-to-Face Auditory Communication

(71) Applicant: Multi-Ears, LLC, St. Louis, MO (US)

(72) Inventors: Jerome R. Cox, JR., St. Louis, MO (US); A. Maynard Engebretson, Chesterfield, MO (US)

(73) Assignee: Multi-Ears, LLC, St. Louis, MO (US)

(21) Appl. No.: 16/229,365

(22) Filed: Dec. 21, 2018

Related U.S. Application Data
(60) Provisional application No. 62/616,533, filed on Jan. 12, 2018.

(51) Int. Cl. H04R 1/10; G06F 3/16; H04R 3/12

(52) U.S. Cl. CPC H04R 1/1083; H04R 1/1016; H04R 2420/07; G06F 3/165; H04R 3/12; H04R 1/1041

(57) ABSTRACT

The present invention describes an enhanced audio communication system which, in certain preferred embodiments, may be employed to advantage in situations involving face-to-face communication between speaking and listening participants within a group located in a noisy environment. In preferred embodiments, the speaking participants and listening participants serve dual roles, both as speakers and listeners. Enhanced audio communication systems for use in face-to-face communication create a specific challenge in implementation, because in this type of face-to-face communication situation, participants experience an augmented reality situation whereby the listening participants hear both the natural auditory signals emanating from the speaking participants and the electronically delivered auditory signals being transmitted via the system, while also seeing the mouth movements of the speaking participants. Thus, the solution for face-to-face communication requires low latency in signal transmission times such that the participants do not experience undesirable “echo” effects whereby the naturally-occurring acoustic signals and the system-delivered electronic auditory signals are undesirably out of sync. In certain exemplary embodiments, the system comprises microphones and receivers that are sized to fit into the ear canals of the speaking and listening participants and housed within earmolds such that unwanted noise emanating from sources external to the system is limited from being transmitted within the system because the earmolds restrict a portion of the external noise from reaching the ear-canal system microphones.

### CROSS REFERENCE TO RELATED APPLICATION

This application claims priority to and the benefit of U.S. Provisional Patent Application No. 62/616,533 that was filed on Jan. 12, 2018, the entirety of which application is hereby incorporated by reference.

### STATEMENT REGARDING FEDERALLY SPONSORED RESEARCH OR DEVELOPMENT

Not applicable.

### SEQUENCE LISTING, TABLE OR COMPUTER PROGRAM ON COMPACT DISC

Not applicable.

### FIELD OF INVENTION

The present disclosure relates generally to the field of auditory enhancement devices, and more specifically to the field of auditory enhancement devices and systems that may be used as augmented reality in multi-party face-to-face applications and have low latency in signal transfer times.

### BACKGROUND OF THE INVENTION

This section provides background information related to the present disclosure, which is not necessarily prior art.

Face-to-face conversations are essential for social and business purposes. Ideally such conversations should be carried out in a quiet environment so that all members of the group can hear each other's speech effortlessly. Today there are many environments in which background noise interferes with understanding the speech for one or more members of the group. Examples are restaurants, business meetings, institutional dining halls, classes on machine tool use, and first-responder organizational meetings at a noisy accident site. The need for assistive auditory communication equipment in face-to-face conversations is increasingly urgent because noisy environments have become increasingly prevalent. Aggravating the problem is the increasing fraction of the population that suffers from age-related hearing loss (presbycusis) or noise-induced (occupational) hearing loss. Such hearing impairments diminish the ability of the auditory system to separate background noise from speech, a phenomenon that further degrades an individual's speech understanding beyond the loss of loudness. Raising one's voice or shouting to overcome ambient noise is not a satisfactory expedient since speech becomes distorted, reducing intelligibility. In addition, a loud voice contributes to the background noise level experienced by others.

Auditory enhancement devices and assistive equipment are well established in modern industry, and are used to augment auditory signals for a variety of purposes. Hearing-impaired individuals benefit from auditory enhancement devices, i.e. hearing aids, and there exist many devices (e.g. headphones, microphones) that enhance hearing and auditory communication between individuals exposed to noisy environments. While solutions exist that successfully enhance person-to-person auditory communication in noisy environments, it is a particular challenge to provide a solution that enhances this type of person-to-person auditory communication in face-to-face settings because signal latency becomes less tolerable when individuals engaged in a conversation are face-to-face and can therefore detect a difference in timing (i.e. a latency) between lip and mouth movements and hearing the sounds associated with that same speech, e.g. the sound is “not in sync” with the face making the sound. Of further complication is the fact that, during face-to-face conversations, any auditory enhancement device or system must also provide a tolerably low latency between the timing of delivery of any “naturally-delivered” auditory signal, i.e. a signal transmitted directly from mouth-of-speaker to ear-of-listener, and the delivery of any “artificially-delivered” auditory signal, i.e. a signal transmitted using mechanical and/or electronic equipment.

An auditory enhancement device for use in face-to-face conversations, in addition to overcoming ambient noise, must therefore also preserve both visual and aural lip synchronization, in order to avoid a “latency echo”. The visual aspects to avoid an unsuitable latency echo are less demanding since it is established that synchronization errors between visual and aural communication elements can be tolerated of 100 milliseconds and more. It is also established that aural synchronization requires that the naturally-delivered acoustic and artificially-delivered electronic paths should ideally match with less than 60 milliseconds latency. This latency echo is typically more noticeable when the ambient noise occasionally falls in level below approximately 75 dBA. Existing Bluetooth and WiFi (IEEE 802.11) wireless protocols have been found to be unsatisfactory in this regard because of their limited bandwidth and excessive latency. This more stringent requirement is most evident when the ambient noise level is variable and drops significantly. In this circumstance, the assistive equipment will provide an experience known as augmented reality, during which group members will simultaneously hear speech over a natural acoustic path and over an augmented electronic path, a path that is essential to the increased understanding of speech in loud ambient noise.

One additional desirable feature of an auditory enhancement device or system for use in certain face-to-face conversations is an absence of bulky or awkward headgear, and/or an absence of a microphone that blocks the mouth—these specific features being particularly important in applications for use in noisy restaurants during dining activities. Another additional desirable feature of an auditory enhancement device or system for use in certain face-to-face conversations is to reduce the environmental noise being transmitted and received through the device or system.

### SUMMARY OF THE INVENTION

This section provides a general summary of the disclosure, and is not a comprehensive disclosure of its full scope or all of its features.

The application herein for the present invention is directed to systems and methods for providing enhanced auditory communication between a group of two or more individuals, and is particularly directed to systems and methods for providing enhanced auditory communication with signal transmission latency at levels low enough to be used in face-to-face communication between a group of two or more individuals.

An exemplary such system for providing enhanced auditory communication between a group of two or more individuals comprises a microphone for each speaking participant in the group that converts the speaker's voice to an electronic signal and then transmits the signal to an external destination. In certain embodiments, the microphone has attachment means such that it can be attached to a speaking participant's clothing or can be suspended near the speaking participant's mouth on a short boom. In exemplary embodiments, the microphone possesses noise-rejecting technology that is readily available commercially. Such a system for providing enhanced auditory communication also comprises a sound-reproducing receiver for each listening participant in the group, which converts the electronic signal that is transmitted from the speaker's microphone into an auditory signal that the listening participant can hear.

Such an auditory enhanced communication system further comprises a Signal Distribution System that has means to process electronic signals being transmitted within the auditory enhanced communication system, such that the Signal Distribution System receives electronic signals from the microphones of each speaking participant in the group and then delivers, via electronic means, the electronic voice signals from each speaking participant in the group to each listening participant in the group. Many such Signal Distribution Systems are commercially available. Exemplary embodiments will employ any of a subset of Signal Distribution Systems, many of which are commercially available, wherein the latency of signal transference time is desirably low. One such commercially available system is the Digitally Enhanced Cordless Telephony (DECT) system, which provides a desirably low latency. In certain exemplary embodiments, the Signal Distribution System supports both DECT and Bluetooth IoT technologies. To clarify, in such blended technology systems, the DECT technology is used for distributing audio signals and the Bluetooth technology is used for controlling the distribution. An example the application of such a blended system for such an exemplary embodiment would comprise an application program (“App”) on a smart phone to adjust the volume of sound delivered from one device to another. Implementation of this technology is straightforward utilizing commercially available chip sets.

In certain exemplary embodiments, the microphone is physically sized to fit directly into the speaking participant's ear canal and thereby detects auditory sounds emanating from the speaking participant's voice directly through the speaking participant's Eustachian tube and body tissues. Placement of the microphone inside the speaking participant's ear canal additionally reduces the opportunity for environmental noise to enter the microphone from noise sources external to the speaking participant's body. In other exemplary embodiments, the receiver is physically sized to fit directly into the listening participant's ear canal, thereby reducing the environmental noise that enters the listening participant's ear canal and increasing the signal-to-noise ratio of auditory sounds the listener can detect from the receiver. In certain preferred embodiments, an individual participant will participate in two (dual) roles: both as a speaking participant and a listening participant. The schematic diagram of FIG. 1 depicts the positioning of a microphone and receiver inside the ear canal of an individual participating in both aforementioned roles. In certain preferred embodiments, the ear-canal microphone and the ear-canal receiver would be positioned in separate ears of an individual participant participating in both roles; in other embodiments the ear-canal microphone and the ear-canal receiver could be positioned in the same ear of an individual participant. In exemplary embodiments wherein the microphone and receiver are co-located in the same ear of an individual participant, an adaptive feedback cancellation algorithm is employed within the system, such that the signal driving the receiver is used as a reference for adaptively cancelling the receiver signal from the microphone signal. In certain exemplary embodiments, the ear-canal microphones will further comprise a filter to compensate for the low-pass nature of the Eustachian tube and eardrum, because the frequency response of signals passed from a speaker's mouth through the speaker's Eustachian tube to the speaker's ear canal may be distorted and require a compensating filter to increase intelligibility. integration of such a filter is straightforward and can be accomplished using commonly accepted digital filtering methods.

In certain other embodiments, microphones are located in or near both ears of the speaking participant rather than one ear. In certain other embodiments, receivers are located in or near both ears of the listening participant rather than one ear.

In other exemplary embodiments, the system for providing enhanced auditory communication between a group of two or more individuals further comprises one or more signal transferal devices, which may be wired or wireless, and which provide a means to efficiently transfer electronic signals between the various microphones and receivers within the system. Many commercially available signal transferal devices can be utilized; one such readily commercially available signal transferal device for wireless communication is an RF transceiver coupled with an antenna. Another alternative is an RF transceiver that broadcasts to all other participants the speaker's voice, and electronic circuits or software at all the receivers that add the voices that are speaking together. This alternative may also include circuitry or software that detects whether a voice is present so that only active channels are added to the signal presented to the listener.

In additional exemplary embodiments, the system for providing enhanced auditory communication between a group of two or more individuals further comprises a power supply, such as one or more batteries, that provide power to some or all of the various microphones and receivers within the system.

In certain exemplary embodiments, all group participants using the system for providing enhanced auditory communication between a group of two or more individuals would participate in dual roles (as speaking participants and as listening participants).

For certain preferred embodiments, the number of group participants, or group members, “G”, is usually small and typically ranges from 2 to 6, although a larger numbers of group members is certainly possible. A schematic of the system required for a dual-role-participant embodiment is illustrated in FIG. 2, which illustrates a preferred embodiment of a system designed for four group members.

As depicted in FIG. 2, the system provides that each group member wears an ear-canal microphone and an ear-canal receiver in opposite ears. The microphones and receivers are all in electronic communication with a Signal Distribution System.

The electronic connections from the microphones to the Signal Distribution System can be wired or wireless, but should be individually connected so that as illustrated in FIG. 2 there are G (herein for illustration, G=4) connections from the G microphones to the Signal Distribution System and G connections from the Signal Distribution System to the G receivers.

It should be evident by the various solutions commercially available that the Signal Distribution System may be in certain embodiments physically concentrated within a single external unit or in other embodiments distributed among the microphones and receivers. In yet other embodiments, the Signal Distribution System may be customized specifically for the application and can therefore be physically in a combination of locations, with some features concentrated and others distributed.

Continuing with the example embodiment where G=4, the relations between the inputs and outputs of the Signal Distribution System is given by the matrix equation,

R=γDM

where R is a G-element column matrix of the receiver input voltages, γ is a scalar system gain parameter, D is a G²-element binary distribution matrix and M is a G-element column matrix of the microphone output voltages. For the G=4 case the square matrix D is,

$$D = [ \begin{matrix}0 & 1 & 1 & 1 \\ 1 & 0 & 1 & 1 \\ 1 & 1 & 0 & 1 \\ 1 & 1 & 1 & 0\end{matrix} ]$$

Thus, in this preferred embodiment, every group member hears the microphone signals from all of the other members, but not from their own microphone signal. This muting of each individual group member's own speech is preferred because their own microphone signal will be delayed in transmission to their receiver causing a disturbing echo due to very stringent signal latency constraints between the sound of their acoustically transmitted voice and the system-provided auditory sound. In a refined embodiment of the D matrix, group members who are not talking can also be muted. This refinement may be preferred for large-G groups. In certain exemplary embodiments, any group member can mute any number of other group members, and can further also selectively mute the outbound sound of that member's own speech so that the outbound sound of that member's speech only transmits to a selected subset of the other group members. Thus, in such exemplary embodiments, the invention would provide the functionality of enabling multiple independent conversations, or “subconversations”, between a subset of the members comprising the entire group. Such a functionality is desirable, for example, when a group of individuals are gathered around a table and various subconversations develop between a subset of the individuals so gathered. At times during such a gathering, it is desirable to converse with the entire group, and at other times the subconversations may be preferred.

The implementation of D can be accomplished in a variety of ways. We describe herein just two embodiments of the many alternatives. First, the microphone can be embodied into a microphone assembly to include a radio frequency transmitter that broadcasts the microphone signal from each speaking participant to all the receiving participants in the group. Prior art is available to make such broadcasts reliable and private. The receiver at each of the other receiving participants receives these broadcasts on separate channels using frequency-division, time-division or code-division multiplexing. The various audio signals are combined according to D producing the desired signal for each listening participant that includes the speech of each of the other speaking participants in the group.

An alternative implementation of D requires C unicast channels between each of the group members. For G members of the group, C=G(G−1)/2 are required. The number of channels C grows rapidly so that for G=2, 3, 4, 5 . . . we have C=1, 3, 6, 10.

Whatever alternative is used for the implementation of D, the latency of the transmission from sending participant to receiving participant should, in preferred embodiments, be less than approximately 60 milliseconds to avoid a disturbing electronic latency echo of speech first delivered acoustically from other group members' lips.

In one embodiment, instead of the unity elements that are off the diagonal of the D matrix, there will be individually adjustable elements. This feature will allow each member of the group to choose the receiver sound output that suits their need. With an appropriate user interface it is even possible for each receiving participant of the group to control the level of the speech he or she hears from each of the other speaking participant in the group. This will require G²−G controls overall, but each individual will see only G−1 controls, one for each of the others in the group.

A preferred embodiment employs an ear-canal microphone and an ear-canal receiver. This arrangement minimizes the surrounding ambient noise exposure of the microphone and, in certain preferred embodiments with the receiver in the opposite ear from the microphone, also minimizes the amount of feedback that is possible over the path between an individual's receiver and microphone. This “opposite ear” arrangement is shown in FIG. 1.

In the preferred opposite ear embodiment, the ear-canal receiver fits in the ear and is housed inside a casing, or earmold, and generates sound that drives the eardrum, but does not produce significant sound outside the head of the individual listening participant member of the conversational group. Similarly, the ear-canal microphone fits in a second earmold and receives sound from the speaker's voice through the physical connection between the speaker's larynx and eardrum, which in turn causes vibration of the speaker's eardrum. The ear-canal microphone is thereby at least partially isolated from the ambient sound that surrounds the speaker's head. In this arrangement, the vibration of the speaker's eardrum arises largely from the speaker's voice originating in the vocal tract and travelling through the Eustachian tube to the middle ear. Bone and tissue conduction of the voice signal plays a minor, additive role in the microphone's input.

Because of the noise isolation provided by the two earmolds, the ambient noise surrounding the individual speaking participant's head plays a negligible role in the microphone input and in the motion of either eardrum. As a result, an improved acoustic signal-to-noise ratio is obtained at both the microphone input and the receiver output. To achieve intelligible conversation among members of the group it is necessary to convert the microphone input from each speaking participant to an electronic signal, transmit it to the receivers in the ear canal of other members of the group and convert the electronic receiver input to an acoustic signal as shown diagrammatically in FIG. 2 for a group of 4.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The drawings described herein are for illustrative purposes only of selected embodiments and not all possible implementations, and are not intended to limit the scope of the present disclosure.

In the drawings:

FIG. 1 illustrates the placement in a participant's ear canal of a microphone and receiver according to certain preferred embodiment.

FIG. 2 illustrates the distribution of audio signals from multiple microphones to multiple receivers in one system embodiment.

### DETAILED DESCRIPTION

Example embodiments will now be described more fully with reference to the accompanying drawings.

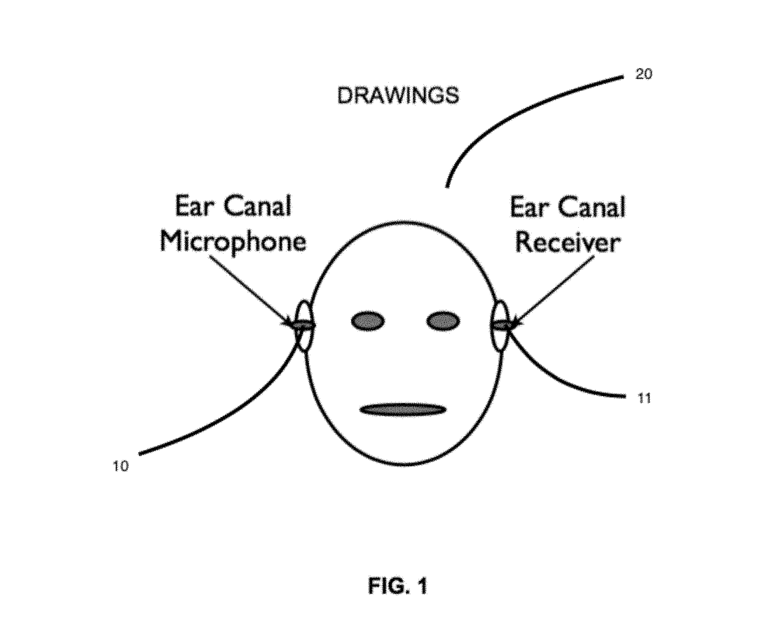

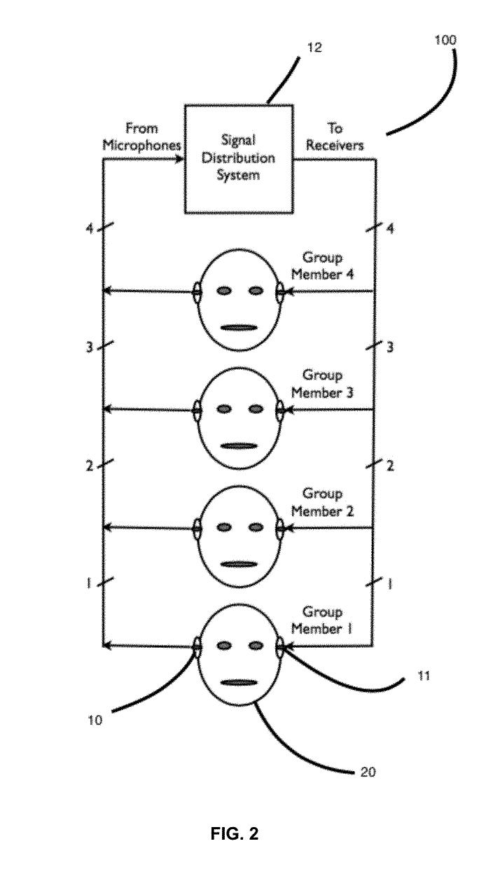

The accompanying drawings illustrate an exemplary embodiment of an enhanced auditory communication system as shown in FIGS. 1 and 2.

Referring now to FIG. 2, a preferred embodiment of an enhanced auditory communication system 100 is depicted for a specific case of a system comprising four individual group members 20. It should be understood that the number of group members chosen is for illustrative purposes only and is not meant to be in any way limiting to the scope of the invention.

Referring now to FIG. 1, a dual-role participant 20 is depicted, wherein dual-role participant 20 is depicted wearing an ear-canal microphone 10 and an ear-canal receiver 11. As shown, FIG. 1 depicts a preferred embodiment wherein the ear-canal microphone 10 and the ear-canal receiver 11 are designed with means such that they may be worn in opposite ears of dual-role participant 20.

Referring again to FIG. 2, the enhanced auditory communication system 100 comprises multiple dual-role participants 20, in the illustrative case depicted, there are four dual-role participants 20. Each dual-role participant 20 is depicted as wearing a microphone 10, depicted specifically as a preferred embodiment ear-canal microphone 10, and also depicted as wearing a receiver 11, depicted specifically as a preferred embodiment ear-canal receiver 11, wherein ear-canal microphone 10 and ear-canal receiver 11 are depicted in the preferred opposite-ear configuration for each dual-role participant 20. As depicted in FIG. 2, the enhanced auditory communication system 100 further comprises a Signal Distribution System 12, or SDS, with means to electronically receive audio communications from individual microphones 10 within the system 100 and to electronically transmit audio communications to individual receivers 11 within the system 100.

The foregoing description of the embodiments has been provided for purposes of illustration and description. It is not intended to be exhaustive or to limit the invention. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the invention, and all such modifications are intended to be included within the scope of the invention.

What is claimed:

1. An enhanced auditory communication system comprising:
at least one microphone with means to receive auditory signals from a speaking participant and convert them to electronic signals;
at least one receiver with means to receive electronic signals and convert them to auditory signals that may be detected by a listening participant and wherein the at least one receiver has means for adjusting the volume of sound being received from each of the at least one microphones; and
at least one signal distribution system with means to receive and deliver electronic signals from the at least one microphone to the at least one receiver within the system, and wherein the at least one signal distribution system has means to receive and deliver electronic signals at a speed such that the latency of signal transfer time for a specific electronic signal being transmitted from the at least one microphone to being received by the at least one receiver is less than 60 milliseconds.

2. The system of claim 1 wherein the at least one microphone possesses the means to reject unwanted noise from sound sources external to the auditory signals originating from the at least one speaking participant of the system.

3. The system of claim 1 wherein the signal distribution system has means to selectively interrupt, or mute, the delivery of electronic signals arriving from any one of the at least one microphones to any one or more than one of the at least one receivers.

4. The system of claim 1 wherein the at least one microphone is an ear-canal microphone sized to fit into an ear canal of a speaking participant.

5. The system of claim 1 wherein the at least one receiver is an ear-canal receiver sized to fit into or near the entrance of an ear canal of a listening participant.

6. The system of claim 5, wherein the at least one microphone is an ear-canal microphone sized to fit into or near the entrance of an ear canal of a speaking participant.

7. The system of claim 6 wherein any one of the at least one microphones and any one of the at least one receivers have means such that they may be utilized by a single dual-role participant such that said participant participates in a dual role, serving as both a listening participant and a speaking participant.

8. The system of claim 7, wherein any one of the at least one microphones and any one of the at least one receivers have means to be positioned in opposite ears of a dual-role participant.

9. The system of claim 7, wherein any one of the at least one microphones and any one of the at least one receivers have means to be positioned in the same ear of a dual-role participant.

10. The system of claim 9, wherein the system comprises an algorithmic means for implementing adaptive feedback cancellation between the auditory signals generated by the at least one receiver and the auditory signals received by the at least one microphone when they are so positioned in the same ear of a dual-role participant.

11. The system of claim 7, wherein the at least one microphone and the at least one receiver are housed in an earmold casing with sealing means to at least partially isolate the eardrums of a dual-role participant from noises originating from natural auditory signals originating from outside the dual-role participant's own body.

12. The system of claim 1 wherein the signal distribution system has means to receive and transmit electronic signals wirelessly between the at least one microphone and the at least one receiver.

13. The system of claim 12 wherein the wireless means of receiving and transmitting comprises a radio frequency transceiver coupled with an antenna.

14. The system of claim 13 wherein the system further comprises at least one power supply with means to provide power to the at least one microphone and the at least one receiver of the system.

15. The system of claim 1 wherein the signal distribution system is physically concentrated within a single unit external to the at least one microphone and the at least one receiver.

16. The system of claim 1 wherein the signal distribution system is physically distributed among the at least one microphone and the at least one receiver.

17. The system of claim 1 wherein the signal distribution system is physically distributed into a combination of locations, with some features distributed among the at least one microphone and the at least one receiver, and some features concentrated within a single unit external to the at least one microphone and the at least one receiver.

18. The system of claim 1 wherein the signal distribution system comprises single channels of communication from each of the at least one speaking participants to each of the at least one listening participants.

19. The system of claim 1 wherein the signal distribution system comprises a means to broadcast the auditory signals from each of the at least one speaking participants.

20. The system of claim 19 where the broadcasting means is wireless.
